(19) United States
(12) Patent Application Publication
(10) Pub. No.: US 2020/0051561 A1
(43) Pub. Date: Feb. 13, 2020

(54) INSTANT KEY MAPPING RELOAD AND REAL TIME KEY COMMANDS TRANSLATION BY VOICE COMMAND THROUGH VOICE RECOGNITION DEVICE FOR UNIVERSAL CONTROLLER

(71) Applicant: Hing Yin Lai, San Jose, CA (US)

(72) Inventor: Hing Yin Lai, San Jose, CA (US)

(21) Appl. No.: 16/535,664

(22) Filed: Aug. 8, 2019

Related U.S. Application Data
(60) Provisional application No. 62/718,164, filed on Aug. 13, 2018.

(51) Int. Cl. G10L 15/22; G06F 3/01; G10L 15/30; A63F 13/355; G05D 1/02

(52) U.S. Cl. CPC G10L 15/22; G06F 3/014; G06F 3/017; G10L 2015/223; A63F 13/355; G05D 1/0202; G10L 15/30

(57) ABSTRACT

Instant key mapping reload and real time key commands translation by voice/gesture command through voice/gesture recognition device for universal controller is disclosed such that a new gesture/motion/voice/game controller requires no special API and can avoids the need for game/app developers to re-write their code, and enables existing game titles/devices to be backward compatible to emerging new voice/motion/gesture controllers, while users can start controlling games/devices using these new voice/motion/gesture controllers directly over a cloud service that performs instant key mapping of commands and realtime translation of commands.

### CLAIM OF BENEFIT TO PRIOR APPLICATION

This application claims benefit to U.S. Provisional Patent Application 62/718,164, entitled “Game controller (mouse, keyboard, joystick, and gamepad) key mapping by voice command through voice recognition device,” filed Aug. 13, 2018. The U.S. Provisional Patent Application 62/718,164 is incorporated herein by reference.

### BACKGROUND

Embodiments of the invention described in this specification relate generally to device control systems, and more particularly, to a key mapping reload and key commands translation system and a key mapping reload and key commands translation process for instantly reloading key mappings and translating key commands for a universal controller in realtime when audibly commanded by a user via a voice recognition device or when hand gesture activated by the user via a motion-sensitive wearable device.

Over the years, very little has changed with the way we play/control games or devices (e.g., videos games, drones, robots)—it is always pressing the same buttons on legacy controller (gamepad, joystick, mouse, and keyboard) or limited to one publisher's library of games that only works with their controller. Specific game control commands on gaming devices (PC, laptop, game consoles, smartphone, etc.) are specifically mapped/bound to various physical controller keys (gamepad, joystick, mouse, and keyboard). It is called key mapping/binding. Each individual game has its own set of key mapping commands. One game's set of key mapping commands might be different from the other game due to different feature of the various games. Same for other electronic devices such as drone and robots control key mappings.

Any new developed form of controllers such as voice and gesture/motion allows a much richer intuitive set of interface to enable user to interact with PC games and other electronic devices more immersive. But they cannot be universal plug & play controller like keyboard or mouse to control various games and other electronic devices because they do not have physical HID keys like legacy controllers.

Most gesture/motion/voice controller solutions are based on creating and releasing an application programming interface (API) to game/app developer which requires developers to rewrite the game/app to enable support for this new controllers.

Therefore, what is needed is a gesture/motion/voice/game controller that requires no special API and can avoid the need for game/app developers to re-write their code and which enables existing game titles/devices to be backward compatible to emerging new voice/motion/gesture controllers.

### BRIEF DESCRIPTION

A novel key mapping reload and key commands translation system and a novel key mapping reload and key commands translation process are disclosed for instantly reloading key mappings and translating key commands for a universal controller in realtime when audibly commanded by a user via a voice recognition device or when hand gesture activated by the user via a motion-sensitive wearable device. In some embodiments, the instant key mapping reload and realtime key commands translation system allows users to start controlling games/devices using these a universal controller via cloud service translation of voice command or gesture command to specific command actionable by a target device or application. In some embodiments, the instant key mapping reload and realtime key commands translation system process is performed by at least one of a voice recognition platform and a motion tracking controller.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a cloud-based architecture of a key mapping reload and key commands translation system in some embodiments.

FIG. 2 conceptually illustrates a key mapping reload and key commands translation process in some embodiments for instantly reloading key mappings and translating key commands for a universal controller in realtime when audibly commanded by a user via a voice recognition device or when hand gesture activated by the user via a motion-sensitive wearable device.

FIG. 3 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications. In this specification, the terms “motion tracking device” and “motion sensitive device” are defined as any hand-held device, wearable device, or headset device, including, without limitation, a wearable bracelet, a smartphone, a handheld dongle, a glove, etc. In this specification, an inertial measurement unit (IMU) is a sensor that captures motion data and is embedded in or on a motion sensitive device, such as motion sensitive wearable devices and motion sensitive handheld devices.

Some embodiments of the invention include a key mapping reload and key commands translation system and a key mapping reload and key commands translation process for instantly reloading key mappings and translating key commands for a universal controller in realtime when audibly commanded by a user via a voice recognition device or when hand gesture activated by the user via a motion-sensitive wearable device. In some embodiments, the instant key mapping reload and realtime key commands translation system allows users to start controlling games/devices using these a universal controller via cloud service translation of voice command or gesture command to specific command actionable by a target device or an application. In some embodiments, the instant key mapping reload and realtime key commands translation system process is performed by at least one of a voice recognition platform and a motion tracking controller.

Embodiments of the key mapping reload and key commands translation system and process described in this specification solve the problems noted above for any existing or future games or electronic devices by way of a universal plug & play motion/gesture/voice controller that is capable of instantly reloading different sets of key mapping/binding commands for specific game/devices before those games/devices start. With a specific set of key mapping tables being loaded, gesture/motion/voice commands are instantly translated to physical keys of legacy controller (such as a gamepad, a joystick, a mouse, or a keyboard) in realtime while a user continues controlling the specific games or devices.

In some embodiments, the key mapping reload and key commands translation system and process work with existing voice recognition platforms. Examples of some existing voice recognition platforms include, without limitation, Amazon Alexa, Google Assistant, Apple Siri, and Microsoft Cortana. In some embodiments, the key mapping reload and key commands translation system and process instantly reloads different sets of key mapping/binding tables for voice/motion/gesture controllers and performs realtime translation of gesture/motion/voice commands to physical keys of legacy controllers (gamepad, joystick, mouse, keyboard). In other words, the instant reload of the key mapping table(s) and realtime control key commands translation are triggered by voice commands on voice recognition devices. In some embodiments, the key mapping reload and key commands translation system and process is backward compatible with any existing game titles or devices which use regular legacy controllers. As such, the key mapping reload and key commands translation system and process ensure that developers need not rewrite their respective games/apps.

Embodiments of the key mapping reload and key commands translation system and process described in this specification differ from and improve upon currently existing options. In particular, some embodiments differ by allowing a gesture/motion/voice controller to be universal plug-and-play controller. The controller does not require any special coding on the game or app developer's side, so a user can use it to control all of their favorite games or devices (e.g., video games, drones, robots, etc.) like any other aftermarket legacy controllers or mouse. The solution scales across any gaming platform and various electronic devices: desktop/laptop PC, gaming consoles, cell phones and tablets, robots, drones, etc.

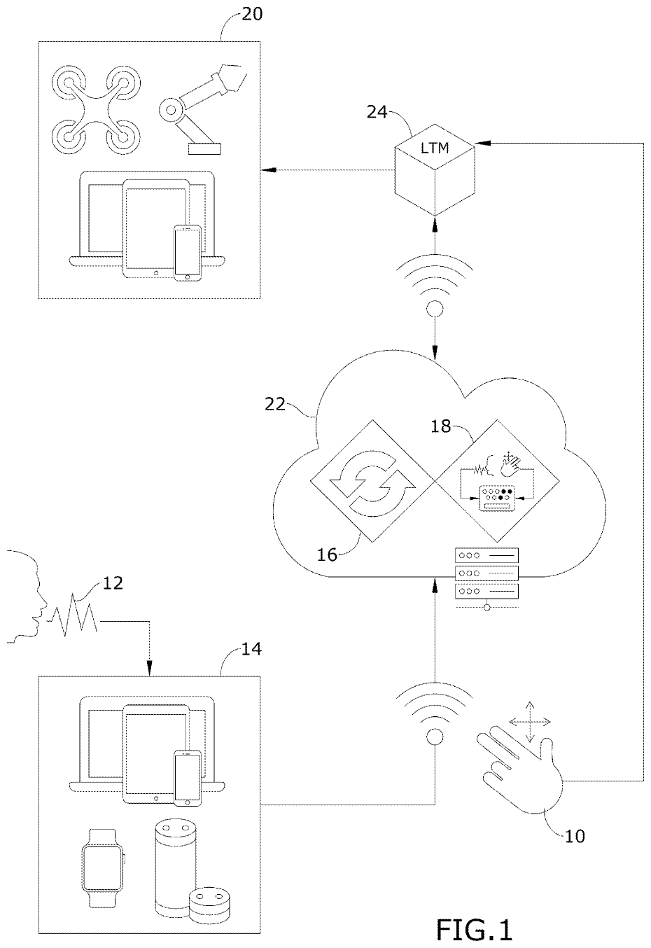

In addition, some embodiments of the key mapping reload and key commands translation system and process improve upon the currently existing options because presently there are thousands of games/devices in the market. With so many games and devices, it is extremely time consuming and almost impossible for game/app developers to rewrite all the games/apps to add API support for a new controller. In addition to time constraints, games and app developers lack motivation to rewrite, since they typically are only find incentive to rewrite controllers which are popular among users. However, given that voice/motion/gesture controllers are relatively new to the market, there is little or no incentive for OEMs or developers to add API support for emerging voice/motion/gesture controllers unless they have already become mainstream. In other words, any new controller that requires an API integration typically has poor backward compatibility with existing games/devices on the market. Nevertheless, the key mapping reload and key commands translation system and process of the present specification bridges this gap so that any new gesture/motion/voice controller would not require a special API, thereby avoiding the need for game/app developers to re-write their code. Furthermore, the key mapping reload and key commands translation system and process enables existing game titles/devices to be backward compatible to emerging new voice/motion/gesture controllers. Users can start controlling games/devices using these new voice/motion/gesture controllers directly a cloud-based service hosted and provided by a key mapping reload and key commands translation system. An example of a cloud-based key mapping reload and key commands translation system is described below, by reference to FIG. 1.

The key mapping reload and key commands translation system of the present disclosure may be comprised of the following elements. This list of possible constituent elements is intended to be exemplary only and it is not intended that this list be used to limit the key mapping reload and key commands translation system of the present application to just these elements. Persons having ordinary skill in the art relevant to the present disclosure may understand there to be equivalent elements that may be substituted within the present disclosure without changing the essential function or operation of the key mapping reload and key commands translation system.

1. Gesture commands controller

2. Voice commands controller

3. Voice recognition devices including smartwatch, smartphone, and laptop

4. Instant reload of key mapping (program)

5. Translation of voice/gesture commands to key commands in realtime

6. Video games in laptop, game console, smartphone, TV, AR/VR goggles, as well as one or more operable devices drones and robots

7. Cloud server that hosts a cloud service

8. Local translation module

By way of example, FIG. 1 conceptually illustrates a cloud-based architecture of a key mapping reload and key commands translation system in some embodiments. As shown in this figure, there is a gesture/motion command controller (or user) 10 and a voice command controller (or user) 12 to interact by gesture, motion, or vocalized command with the key mapping reload and key commands translation system. Additionally, the key mapping reload and key commands translation system includes any one or more of several voice recognition devices 14, an instant reload of key mappings program 16, realtime translation of voice/gesture commands into key commands 18, any one or more of several command receiving electronic systems/devices 20, a key mapping reload and key commands translation cloud service 22 (or shortened to “cloud service 22”) that is hosted on a cloud server and through which the instant reload of key mappings program 16 runs to provide, in response to voice/gesture commands transmitted over a network (the Internet) to the key mapping reload and key commands translation cloud service 22 (hosted by and running on the cloud server) from the voice recognition devices 14, realtime translation of voice/gesture commands into key commands 18. Finally, the key mapping reload and key commands translation system also includes a local translation module 24.

The key mapping reload and key commands translation system generally works by the gesture/motion command controller (or user) 10 moving a body part (such as a hand) with a motion-sensitive device that is either a handheld device (such as a smartphone or a dongle) or a wearable device (such as a bracelet or a glove which includes a gyroscope and an inertial measurement unit (IMU) for capturing motion data when moving the body part) or by the voice command controller (or user) 12 user talking to a voice recognition device 14. When the user 10 gestures or moves or when the user 12 speaks to the voice recognition device 14, the cloud-based software processes—including the instant reload of key mappings program 16 and realtime translation of voice/gesture commands into key commands 18—capture the audio or motion data and translate by mapping. In other words, the user 10/user 12 activates the cloud-based software processes of the cloud service 22 to run on the cloud server, the cloud service 22 will be in standby mode waiting for user requests in the form of data inputs (voice audio or motion capture data) that are triggered by user actions, including speaking voice commands into the voice recognition device 14 and/or providing motion/movement based gesture commands through movement of the motion-sensitive wearable or handheld device (e.g., a smartphone, a dongle, or a bracelet with at least a gyroscope and an inertial measurement unit (IMU)). Once users indicate specific names of games/applications/devices he/she is going to play, use, or control (e.g., “Destiny 2” or “Parrot drone”), the cloud service 22, via the instant reload of key mappings program 16, instantly loads the corresponding set of key mappings. When users are playing or controlling the games/applications/devices, the voice recognition device is listening to user's voice while gesture/motion controller (a handheld device, e.g., a smartphone or a dongle, or a wearable device, e.g., a bracelet or a glove) is detecting user hand/body gesture/motion. While the user speaks and/or moves in realtime, the cloud service 22 running on the cloud server also translates the voice/gesture commands in realtime via the realtime translation of voice/gesture commands into key commands 18, based on the already loaded mapping table(s) loaded by the instant reload of key mappings program 16 running on the server in connection with the cloud service 22.

For voice control, when users pronounce a voice control command for the games/applications/devices which users are controlling or playing (e.g., fire, jump, duck, next weapon, drone flip forward, etc.), the realtime translation of voice/gesture commands into key commands 18 occurs at the cloud service 22, thereby translating the voice command to a specific physical control key command (gamepad, keyboard, mouse, joystick), based on the key mapping table loaded by the instant reload of key mappings program 16 of the cloud service 22. Then the cloud service 22 sends the specific physical control key command to the local translation module 24 which relays the specific physical control key command to the target electronic system/device 20 (e.g. laptop, game console, smartphone, etc.) where the game is running or to which the specific physical control key command applies (e.g., application for another device, or a drone or a robot). The specific physical control key command will then trigger a specific action of the game/application that corresponds to the specific physical control key command (per the mapping table) and is equivalent to a conventional physical activation or triggering of a keyboard, a gamepad, a mouse, a joystick, etc., to trigger the actions that the user intends to control.

For motion control, when users perform specific hand/body motions for the games/applications/devices which he or she is playing or controlling, the motion/movement data is captured by the motion-sensitive wearable or handheld device of the gesture/motion command controller (or user) 10 and provided to either the local translation module 24 or the cloud service 22. When the cloud service 22 gets the motion/movement data, it maps the defined motion pattern to the gesture/motion control command (fire, jump, duck, next weapon, drone fly forward, drone fly backward, drone fly up, drone fly down, etc.). Again, the corresponding mappings are loaded by the instant reload of key mappings program 16 when the wearable device is detected, so that when the cloud service 22 gets the gesture/motion data, it performs the realtime translation of the gesture commands into key commands 18. Thus, the user command expressed by the motion/movement data is translated to a specific physical control key command (for a gamepad, a keyboard, a mouse, a joystick, etc.). The specific physical control key command is passed through the location translation module 24 to the target electronic system/device 20 on which the game/application is running or which itself is the action-performing device (e.g., drone, robot). However, when the motion/movement data (also referred to as gesture/motion data) is sent to the local translation module 24, then all of the realtime translation of the gesture commands into key commands 18 is performed there by a local instance of the instant reload of key mappings program 16. The resulting specific physical control key command is thereafter passed to the target device/system 20, such that the specific physical control key command will then trigger specific action(s) of the game/application equivalent to how user performs them conventionally by a physical controller device (e.g., press a keyboard, or gamepad, or mouse, or joystick) to trigger the actions.

In some embodiments, if the user did not pronounce and specify the name of game/application/device to voice recognition devices before controlling or playing specific (target) game/application/device, the instant reload of key mappings program 16 will not know which specific set of key mappings should be loaded for key command translation to the target game/application/device. Without a correct set of key mappings for a target game/application/device, the voice/motion controller will not trigger the right actions of the target game/application/device.

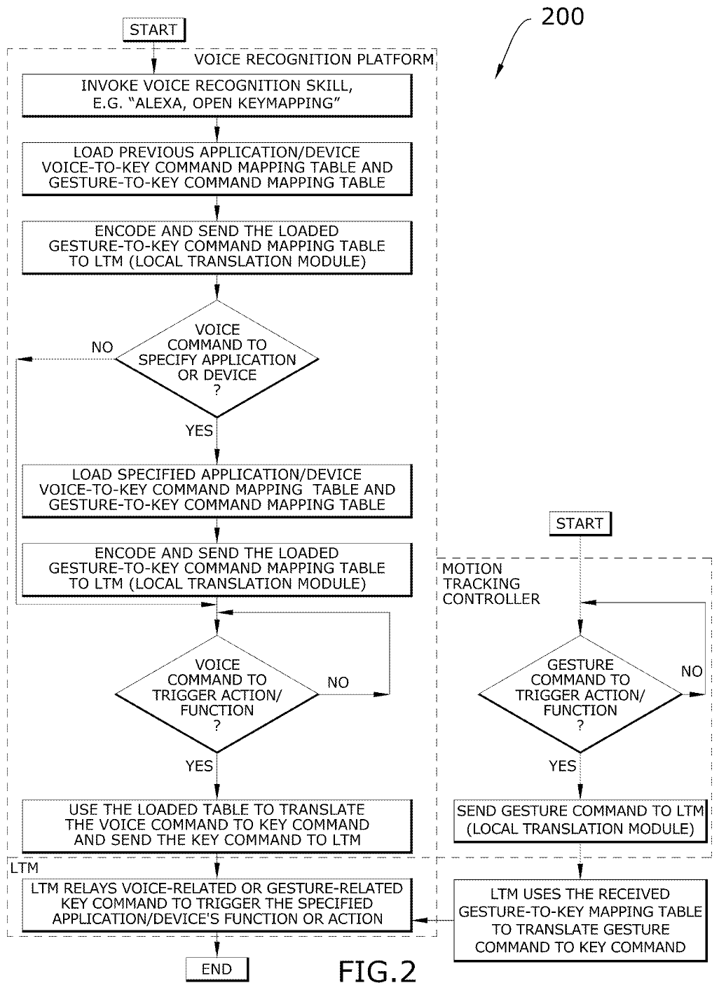

To make the key mapping reload and key commands translation system of the present disclosure, one may use voice recognition platform to create the software (which carries out at least part of the key mapping reload and key commands translation process) with voice control support. One would need to write the protocol of communication to complete the transaction between the user control devices like voice/gesture controllers, the cloud service 22, and local translation module 24. Then one would need to build an algorithm to map and translate commands into game/application/device specific actions or functions, then build as software implementation of the algorithm (an example of which is described below, by reference to FIG. 2). Finally one would need to setup an interface to deliver the transformed commands from local translation module to the target game/application/device platforms to execute the command for specific actions or functions. These transformation from commands to actions/function needs to be completed within a given set of time to avoid user seeing lag or delay in response between user issuing commands and seeing the effect.

By way of example, FIG. 2 conceptually illustrates a key mapping reload and key commands translation process for instantly reloading key mappings and translating key commands for a universal controller in realtime when audibly commanded by a user via a voice recognition device or when hand gesture activated by the user via a motion-sensitive wearable device. As shown in this figure, when the universal controller is associated with a voice recognition platform, the key mapping reload and key commands translation process starts by invoking a voice recognition skill. An example of a voice recognition skill is a vocal command, such as “Alexa, open key mapping”. Next, the key mapping reload and key commands translation process loads the previous target application/device voice-to-key command mapping table and gesture-to-key command mapping table. Once loaded, the key mapping reload and key commands translation process encodes and sends the loaded gesture-to-key command mapping table to the location translation module.

The key mapping reload and key commands translation process then determines whether a voice command is detected to specify a target application or device. When detected, the key mapping reload and key commands translation process loads a specified (target) application/device voice-to-key command mapping table and gesture-to-key command mapping table. The key mapping reload and key commands translation process then encodes and sends the loaded gesture-to-key command mapping table to the local translation module (LTM).

When there is not voice command detected to specify a target application or device, or after loading the specified application/device voice-to-key command mapping table and gesture-to-key command mapping table followed by encoding and sending the loaded gesture-to-key command mapping table to the LTM, then the key mapping reload and key commands translation process determines whether a voice command is detected to trigger an action/function. When no voice command is detected, the key mapping reload and key commands translation process loops back to listen for a voice command and continues to loop back and listen until a voice command is captured. On the other hand, when a voice command is detected, the key mapping reload and key commands translation process uses the loaded table to translate the voice command to the key command and sends the key command to the LTM. Next, the key mapping reload and key commands translation process (at the LTM) relays the voice-related or gesture-related key command to the target device/application to trigger the specified function or action at the target device or application.

On the other hand, when the universal controller is associated with a motion tracking controller, the key mapping reload and key commands translation process starts by determining whether there is a motion/movement command to trigger an action/function. When there is no motion/movement command from the user, the key mapping reload and key commands translation process loops back to wait for any such motion/movement indicative of a command from the user. However, when there is a gesture of a command detected, the key mapping reload and key commands translation process sends the gesture command to the LTM and the LTM uses the received gesture-to-key mapping table to translate the gesture command to the key command (for the target device). Next, the key mapping reload and key commands translation process (at the LTM) relays the voice-related or gesture-related key command to the target device/application to trigger the specified function or action at the target device or application. Then the key mapping reload and key commands translation process ends.

The key mapping reload and key commands translation system and/or process is not only limited to voice controller or gesture/motion controller. The key mapping reload and key commands translation system/process can be reconfigured and installed in the cloud or in local devices to support new form of controller and translate new controller commands to control key commands (e.g., keyboard, gamepad, mouse, joystick, etc.) recognized by games/application/electronic devices. In some embodiments, part of the software can be reconfigured and installed to run on smartphone/smartwatch/PC app, to allow a user to use the app without voice command support to specify the name of game/application/devices which user want to control or play. User can use the app to change or customize the set of key mapping.

To use the key mapping reload and key commands translation system/process of the present disclosure, each original equipment manufacturer (OEM) who makes voice/gesture/motion controllers will be able to install firmware into their controller and local translation module, where the firmware implements the key mapping reload and key commands translation system in complete, embedded form. Once our firmware has been installed and authenticated, any voice/gesture/motion controller with local translation module can be plug & play like legacy controller such as keyboard, gamepad, mouse and joystick to control games/application/devices on any electronic platforms such as PC, smartphone, tablets, gaming consoles, drones, robots and etc.

End users on the other hand, would need use the app and voice skills to setup a voice control account to access the software solution and service. Once the service has been activated, user can now start to play or control games/applications/devices on any platform by the voice/gesture/motion controllers.

Additionally, the key mapping reload and key commands translation system/process with voice control can also apply to complex smart home, industrial, commercial control such as home appliances, industrial robot or surveillance system including drone, or camera. The key mapping reload and key commands translation system/process can even be adapted for use by any system which requires real time translation of one type of complex control commands to another type of complex control commands.

Also, the key mapping reload and key commands translation system/process results in a virtual universal controller including keyboard, mouse, gamepad, joystick, voice, gesture and motion controller across various platforms and applications. The controller become plug and play just like those aftermarket/legacy keyboard, mouse, gamepad, joystick. Our software can transform one type of controller to another type of controller in real time.

In this specification, the term “software” is meant to include applications stored in magnetic storage, which can be read into memory for processing by a processor. In some embodiments, the software, when installed to operate on one or more electronic systems, define one or more specific machine implementations that execute and perform the operations of the software. In particular, the processes described above may be implemented as software processes that are specified as a set of instructions recorded on a computer readable storage medium (also referred to as a non-transitory computer readable medium). When these instructions are executed by one or more processing unit(s), they cause the processing unit(s) to perform the actions indicated in the instructions. Examples of computer readable media include, but are not limited to, CD-ROMs, flash drives, RAM chips, hard drives, EPROMs, EEPROMs, etc. The computer readable media does not include carrier waves and electronic signals passing wirelessly or over wired connections.

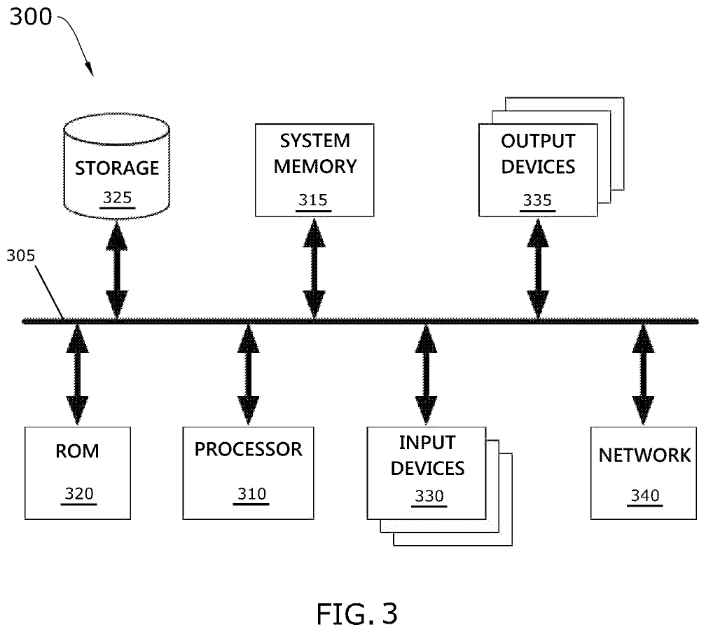

By way of example, FIG. 3 conceptually illustrates an electronic system 300. The electronic system 300 may be any computing device, such as a desktop or laptop computer, a tablet, a smart phone, or any other sort of electronic device. Such an electronic system includes various types of computer readable media and interfaces for various other types of computer readable media. Electronic system 300 includes a bus 305, processing unit(s) 310, a system memory 315, a read-only 320, a permanent storage device 325, input devices 330, output devices 335, and a network 340.

The above-described embodiments of the invention are presented for purposes of illustration and not of limitation.

I claim:

1. A key mapping system comprising:
a gesture command controller;
a voice command controller that embeds within a voice recognition device to capture voice commands from a user;
a cloud server that hosts a cloud service to perform instant key mapping reload services and realtime key commands translation services to translate vocal commands to platform-specific commands that are associated with a specific target platform;
an instant reload of key mapping program that runs on the cloud server to load a specific key mapping table associated with the specific target platform;
a realtime translation of voice and gesture commands to key commands program that runs on the cloud server and translates vocal and gestural input data into specific target platform commands; and
a local translation module (LTM) that passes specific target platform commands to the specific target platform.

2. The key mapping system of claim 1, wherein the specific target platform comprises one of a target electronic device, a target gaming application that runs on a target gaming console, and a target operable device.

3. The key mapping system of claim 2, wherein the target electronic device comprises one of a laptop computing device, a smartphone, a tablet computing device, a television (TV), and an augmented reality/virtual reality (AR/VR) goggles headset.

4. The key mapping system of claim 2, wherein the target operable device comprises one of an aerial drone, a land vehicle drone, and a water vehicle drone.

5. The key mapping system of claim 2, wherein the target operable device comprises a robot.

6. The key mapping system of claim 1, wherein the voice command controller comprises a voice command app on a specific voice recognition device and the gesture command controller comprises one of a handheld device and a motion-sensitive wearable device worn by a user.

7. The key mapping system of claim 6, wherein the motion-sensitive wearable device comprises an embedded gyroscope, an embedded inertial measurement unit (IMU), and a wireless transmitter to wirelessly transmit, to one of the LTM and the cloud service for processing, motion data captured by the embedded IMU when the user moves the wearable bracelet.

8. The key mapping system of claim 1, wherein the specific key mapping table comprises a plurality of vocal commands that are translated into a plurality of corresponding actions performed by the specific target platform.

9. The key mapping system of claim 1, wherein the plurality of vocal commands comprises a fire vocal command listing, a jump vocal command listing, a duck vocal command listing, and a next weapon vocal command listing, wherein the specific target platform comprises a particular video game console.

10. The key mapping system of claim 1, wherein the plurality of vocal commands comprises a drone fly forward vocal command listing, a drone fly backward vocal command listing, a drone fly up vocal command listing, and a drone fly down vocal command listing, wherein the specific target platform comprises a particular aerial drone.
